(19) United States
(12) Patent Application Publication
(10) Pub. No.: US 2012/0127469 A1
(43) Pub. Date: May 24, 2012

(54) FLOW CELL, DETECTOR, AND LIQUID CHROMATOGRAPH

(75) Inventors: Nobuhiro Tsukada, Hitachinaka (JP); Shigenori Togashi, Abiko (JP); Yoshihiro Nagaoka, Ushiku (JP); Tomohiro Shoji, Hitachinaka (JP)

(73) Assignee: HITACHI HIGH-TECHNOLOGIES CORPORATION, MINATO-KU, TOKYO (JP)

(21) Appl. No.: 13/388,765

(22) PCT Filed: Jun. 18, 2010
(86) PCT No.: PCT/JP2010/004072

§ 371 Date: Feb. 3, 2012

(30) Foreign Application Priority Data
Sep. 30, 2009 (JP) 2009-225879

(51) Int. Cl. G01N 21/59

(52) U.S. Cl. 356/436

(57) ABSTRACT

In a liquid chromatograph, a flow cell, in which a direction of detecting light and a flow direction of a sample fluid are parallel to each other, and in which the flow direction of the sample fluid changes at the moment of the sample fluid flowing out of a detecting portion into an outflow channel and at the moment of the sample fluid flowing into the detecting portion from an inflow channel, is capable of suppressing a peak broadening of a chromatogram. A plurality of outflow channels are provided, which shorten a distance between a flow outlet and a flow bend in the sample flow. A plurality of inflow channels are also provided, some of which collide jets flowing into the detecting portion from the inflow channels and others of which produce a swirl of jets flowing into the detecting portion from the inflow channels.

### FIELD OF THE INVENTION

The present invention relates to a flow cell, a detector, and a liquid chromatograph, specifically, a liquid chromatograph measuring an absorbance of a liquid sample flowing inside a flow cell.

### DESCRIPTION OF THE RELATED ART

In a liquid chromatograph, an ultraviolet absorbance detector is most widely used to measure a sample fluid processed by a separation column (see non-patent document 1). The Lambert-Beer's law tells that an absorbance is expressed in the following formula,

A=εcl=log(Io/I)

wherein: A is the absorbance; E is a mol absorbance coefficient; c is a mol concentration; l is a length of an optical path; Io is an intensity of an incident light; and I is an intensity of a passing light. The formula indicates that the absorbance A is proportional to the length of the optical path 1. Generally, a signal generated by a photo detector measuring the intensity of the passing light I in a measurement of the absorbance A is proportional to an intensity of a received light, while a noise that is simultaneously detected is proportional to the square root of the intensity of the received light. Therefore, a signal-to-noise ratio is proportional to a square root of the intensity of the received light. Meanwhile, the intensity of the received light by the photo detector is proportional to a light incident area. Therefore, the signal-to-noise ratio of the photo detector is proportional to the square root of the light incident area. Therefore, in order to ensure a signal-to-noise ratio large enough for detecting a subject substance with an absorbance measurement, an optical path and a light incident area having more than a certain level of length and area are needed.

Normally, an inner diameter of tubing used for a liquid chromatograph is as small as around 0.1 mm, and this inner diameter is so small that the absorbance measurement can not acquire an adequate level of the optical path length and the light incident area. Therefore, in order to acquire an optical path length and a light incident area large enough for the detection, a channel called flow cell having an adequate channel length and channel width is employed.

The conventional technology provides a flow cell having the structure disclosed in patent document 1.

The channel of the flow cell comprises:
a detecting portion receiving a detecting light incident on the detecting portion;
an inflow channel leading a sample fluid from an upstream tube into the detecting portion; and
an outflow channel leading a sample fluid out of the detecting portion into a downstream tube.

The detecting portion has a capacity of 3 to 15 μl, a length of 3 to 10 mm, and a inner diameter of 0.5 to 1.5 mm. An emitting direction of a detecting light and a flow direction of a sample fluid are parallel to each other. The flow direction of the sample fluid changes greatly at the moment the sample fluid is flowing from an inflow channel into the detecting portion as well as at the moment of flowing out of the detecting portion into an outflow channel.

Patent document 2 discloses a flow cell, which makes the concentration of a sample fluid even across a cross section of a channel by generating a vortex inside a detecting portion with the sample fluid passing through a vortex-generating channel to flow into the detecting portion. Like other conventional flow cells, in the flow cell of patent document 2, an emitting direction of a detecting light and a flow direction of a sample fluid are parallel to each other and the flow direction of the sample fluid changes greatly at the moment the sample fluid is flowing from an inflow channel into the detecting portion as well as at the moment of flowing out of the detecting portion into an outflow channel.

Each of patent documents 3, 4, and 5 discloses a flow cell provided with a plurality of inflow channels in order to evenly lead a sample fluid into a detecting portion. In these flow cells, an emitting direction of a detecting light and a flow direction of the sample fluid are different from each other, and the flow direction of the sample fluid is almost constant through the inflow channel, the detecting portion, and an outflow channel.

### LIST OF PRIOR ART DOCUMENTS

### Patent Documents

JP1997-170981A
JP2001-099822A
JP1996-278247A
JP1997-127086A
JP2001-510568A

### Non-Patent Documents

“Chemistry Seminar: Chromatography 2nd edition—the mechanism of separation and its application” by Takao Tsuda, published by Maruzen, Tokyo

### OBJECTIVES OF THE INVENTION

An objective for the present invention to attain is to suppress a peak broadening of a chromatogram caused by a flow cell, in which an emitting direction of a detecting light and a flow direction of a sample fluid are parallel to each other, and in which the flow direction of the sample fluid changes at the moment the sample fluid is flowing from an inflow channel into the detecting portion as well as at the moment of flowing out of the detecting portion into an outflow channel.

In the conventional flow cell of patent document 1, the flow of the sample fluid is stagnated at a flow inlet connecting an inflow channel and a detecting portion, and at a flow outlet connecting the detecting portion and an outflow channel. A sample molecule trapped in the stagnation stays longer in the detecting portion than a sample molecule free from the stagnation, leading to a peak broadening of a chromatogram.

The stagnation around the flow outlet is caused by a change in the flow direction of the sample fluid. When the emitting direction of the detecting light and the flow direction of the sample fluid are parallel to each other, an end face of the detecting portion provides a cross section of the detecting portion for the detecting light to pass through. Inevitably, the flow outlet is disposed on a side face of the detecting portion forcing the sample fluid to change its flow direction at the moment the sample fluid is flowing out of the detecting portion into the outflow channel. This change in the flow direction is accompanied by a reduction of the flow rate around a corner defined by the bending flow of the sample fluid (Hereinafter, the corner is referred to as “the flow bend”.). Then, the stagnation is generated around the flow bend. Therefore, the farther away from the flow outlet is positioned the flow bend, the longer the sample molecule takes to come out of the detecting portion.

On the other hand, around the flow inlet, the channel width is abruptly widened, causing the flow of the sample fluid to be detached from a channel wall. As a result, a vortex is generated and the vortex causes the stagnation. Once a sample molecule is trapped in the vortex, only a molecular diffusion allows the trapped molecule to come out of the vortex. A rate of motion of a molecule driven by the molecular diffusion is determined by a diffusion coefficient, which is a property attributed to the interaction between the sample molecule and a solvent, and is independent of the flow rate of the sample fluid. Therefore, the larger is the scale of the vortex trapping the sample molecule, the longer the trapped molecule takes to come out of the vortex. As a result, the sample molecule accordingly takes longer time to come out of the detecting portion.

In the flow cell disclosed in patent document 2, a generated vortex around a flow inlet is such a type that rather diminishes the stagnation into a smaller scale than the vortex in a conventional flow cell. The flow outlet, however, has a same configuration as a flow outlet in a conventional flow cell. Therefore, the flow cell of patent document 2 suffers from a flow stagnation around the flow outlet to the same extent as a conventional flow cell.

In the flow cells disclosed patent documents 3, 4, and 5, an emitting direction of a detecting light and a flow direction of a sample flow in a detecting portion are different from each other, and the flow directions of the sample fluid in an inflow channel and in the detecting portion are same as each other. The detecting portion is provided with a plurality of inflow channels connected to the detecting portion and having a smaller width than the width of the detecting portion. Therefore, the flow inlets generate vortices, which cause flow stagnations.

An objective for the present invention to attain is to suppress a peak broadening of a chromatogram caused by a flow cell.

### Means to Attain the Objectives

A flow cell of the present invention comprises:
a detecting portion, in which a sample fluid is irradiated with a detecting light;
an inflow portion leading the sample fluid into the detecting portion in a direction different from a flow direction of the sample fluid inside the detecting portion; and
an outflow portion leading the sample fluid out of the detecting portion in a direction different from the flow direction of the sample fluid inside the detecting portion;
in such a way that an emitting direction of the detecting light and the flow direction of the sample fluid inside the detecting portion are parallel to each other,
   wherein,

the outflow portion is provided with one or more channels leading the sample fluid out of the detecting portion in a plurality of directions.

### Advantages of the Invention

A flow cell of the present invention suppresses a peak broadening of a chromatogram, improving an accuracy of analysis with a liquid chromatograph.

### DESCRIPTION OF PREFERRED EMBODIMENTS

By means described in the following paragraphs, the present invention can suppress a peak broadening of a liquid chromatogram produced by a flow cell. In the flow cell an emitting direction of a detecting light and a flow direction of a sample fluid are parallel to each other inside a detecting portion. Also, in the flow cell, the flow direction of the sample fluid changes at the moment when the sample fluid is flowing from an inflow channel into the detecting portion as well as the moment of flowing out of the detecting portion into an outflow channel.

The first means is a disposition of a plurality of outflow channels to shorten a distance between the flow outlet and a flow bend, where the stagnation occurs, in order to diminish a flow stagnation around a flow outlet inside the detecting portion. In this manner, a sample molecule trapped in the stagnation can come out of the detecting portion in a shorter time.

The second means is a disposition of a plurality of inflow channels symmetrical with respect to the central axis of the detecting portion to collide jets of the incoming sample fluid from the inflow channel into the detecting portion in order to diminish a flow stagnation around a flow inlet inside the detecting portion. In this manner, directions of the generated jets are symmetrical with respect to a central plane including the central axis of the detecting portion scaling down a vortex as well as enabling a sample molecule to come out of the vortex in a shorter time.

The third means is a disposition of a plurality of inflow channels leading the sample fluid into a detecting portion in directions offset from a direction to the central axis of the detecting portion to generate a circular flow of an incoming jet from the inflow channel into the detecting portion in order to diminish a flow stagnation around a flow inlet inside the detecting portion. In this manner, one vortex generated by a circling flow is offset by another vortex generated by another circling flow scaling down the entire vortex as well as enabling a sample molecule to come out of the vortex in a shorter time.

The first means may be combined with either the second or the third means to further suppress a peak broadening of a chromatogram.

In following paragraphs, a configuration of a liquid chromatograph device of the present invention is described with reference to FIG. 1. The liquid chromatograph comprises a liquid supply pump 101, a sample injector 102, a separation column 103, a detector 104, tubing 105 for connecting the aforementioned components, and a recorder 106 for recording an output from the measurement with the detector 104. The detector is provided with a flow cell 1, a light source 108, and a photo detector 107. A measurement of an absorbance of a sample fluid is completed when a detecting light 109 is emitted from the light source 108, passes through a sample fluid flowing inside the flow cell, and is received by the photo detector 107.

FIG. 2 presents a schematic view of a chromatogram, which is the change rate of the absorbance with respect to time. An objective for the present invention to attain is to suppress a chromatogram peak broadening that is recorded by the recorder 106 as shown in FIG. 2. As a result of the suppression of a peak broadening, an accuracy of analysis with a liquid chromatograph is improved well enough for the detection of even smaller amount of sample.

### Example

### Working Example 1

In following paragraphs, the first working example of the present invention is described with reference to FIGS. 3, 4, and 5.

FIG. 3 illustrates a flow cell 1 comprising a detecting portion 2, one single inflow channel 3, two of branched outflow channels 41, 42, and a rejoining outflow channel 45. A sample fluid, which flows from an upstream tube 5 into the flow cell 1, is led from the single inflow channel 3 through a flow inlet 300 into the detecting portion 2, is further led from the detecting portion 2 through flow outlets 401, 402, into the branched outflow channels 41, 42, and rejoins downstream into a single stream to flow through the rejoining outflow channel 45 into a downstream tube 6. The emitted detecting light 109 comes through an upstream end face of detecting portion 201 into the detecting portion 2, and goes out of the detecting portion 2 through a downstream end face of detecting portion 202. Alternatively, the emitted detecting light 109 may come through the downstream end face of detecting portion 202 into the detecting portion 2, and may go out of the detecting portion 2 through the upstream end face of detecting portion 201.

In this configuration, the presence of the two flow outlets 401, 402 shortens a distance between the flow outlets and the flow bend. As a result, it takes a shorter time for a molecule to move from the flow bend to a branched outflow channel, which is the reason for a suppression of a peak broadening of a liquid chromatogram. The outflow channels 41, 42 are preferably disposed to be symmetrical with respect to a central plane of detecting portion 22 including the central axis of detecting portion 21 in order to minimize the distance between the flow bend and the branched flow outlet.

FIG. 4 illustrates a flow cell comprising three branched outflow channels 41, 42, 43. The number of the outflow channels is not limited to three, and the flow cell 1 may be provided with more than three outflow channels.

The larger is the number of the outflow channels, the shorter becomes the distance between the flow outlets inside the detecting portion 2 and the flow bend. Therefore, accordingly, it takes a shorter time for a molecule to move from the flow bend to a branched outflow channel. More than three of the outflow channels are also preferably disposed to be symmetrical with respect to the central axis of detecting portion 21.

FIG. 5 illustrates a flow cell 1 comprising an encircling outflow channel all along a circumference of the detecting portion 2. The illustrated flow cell is virtually the flow cell shown in FIG. 4 provided with an infinite number of outflow channels.

The present invention shortens the distance between the flow outlets and the flow bend, accordingly making it take a shorter time for a molecule to move from the flow bend to a branched outflow channel than in a conventional flow cell, which is the reason for a suppression of a peak broadening of a liquid chromatogram. As a result, the accuracy of analysis of a liquid chromatograph can be improved.

### Working Example 2

In following paragraphs, the second working example of the present invention is described with reference to FIG. 6.

FIG. 6 illustrates a flow cell 1 comprising a detecting portion 2, two branched inflow channels 31, 32, and two branched outflow channels 41, 42. The two branched inflow channels 31, 32 are disposed to be symmetrical with respect to the central plane of detecting portion 22 including the central axis of detecting portion 21. The sample fluid, which flows from an upstream tube 5 into the flow cell 1, is led from the branched inflow channels 31, 32 through flow inlets 301, 302 into the detecting portion 2, is further led from the detecting portion 2 through the flow outlets 402, 402 into the branched outflow channels 41, 42, and rejoins downstream into a single stream to flow through the rejoining outflow channel 45 into the downstream tube 6. The number of the outflow channels does not have to be restricted to two, and the flow cell 1 may be provided with a single outflow channel like a conventional flow cell, with more than two of the outflow channels as shown in FIG. 4, or with an encircling outflow channel disposed all along a circumference of the detecting portion as shown in FIG. 5. The emitted detecting light 109 comes through an upstream end face of detecting portion 201 into the detecting portion 2, and goes out of the detecting portion 2 through a downstream end face of detecting portion 202. Alternatively, the emitted detecting light 109 may come through the downstream end face of detecting portion 202 into the detecting portion 2, and may go out of the detecting portion 2 through the upstream end face of detecting portion 201.

In the mechanism of a generation of a stagnation around the flow inlet inside the detecting portion 2, an abrupt enlargement of the channel width at the flow inlet causes the flow of the sample fluid to be detached from the channel wall, subsequently making the detached flow a jet accompanied by a generation of a vortex, which is the cause of the stagnation. The longer is the distance, in which the jet is sustained, the larger the vortex grows. In a conventional flow cell provided with a single inflow channel, the incoming jet does not dissipate until the jet hits a surface of a wall of a detecting portion. On the other hand, in the flow cell 1 of the present invention, the branched inflow channels 31, 32 are disposed to be symmetrical with respect to the central plane of detecting portion 22 including the central axis of detecting potion 21, leading incoming jets from the branched inflow channels 31, 32 to collide with each other on the central plane of detecting portion 22. The collision dissipates the jets on the central plane of detecting portion 22. Therefore, the flow cell 1 of the present invention has a shorter distance, in which the jet is sustained, than a conventional flow cell. Accordingly, the vortex generated by the jet is scaled down. As a result, a sample molecule can come out of the vortex in a shorter time, leading to a suppression of a peak broadening of a liquid chromatogram.

As shown in FIG. 6, with a flow cell, in which the inflow channels as well as the outflow channels are disposed to be symmetrical with respect to the central axis of detecting portion, a peak broadening of a chromatogram is particularly suppressed when the photo intensity distribution of the detecting light has the highest intensity at the central axis of the detecting portion. In the filed of flow inside the detecting portion, a flow rate of the sample fluid is large at the central axis of detecting portion and small near a surface of an inner wall of the detecting portion. Therefore, the majority of sample molecules flow along the central axis of the detecting portion. Because the intensity of the detecting light is more heavily distributed at the central axis than near the surface of the inner wall, the sample molecules flowing along the central axis make the larger contribution to a concentration of the detectable molecules. In this manner, a peak broadening of a chromatogram is suppressed.

The present invention scales down a vortex generated around a flow inlet inside a detecting portion, leading to a suppression of a peak broadening of a liquid chromatogram. As a result, the accuracy of analysis of a liquid chromatograph can be improved.

### Working Example 3

In following paragraphs, the third working example of the present invention is described with reference to FIG. 7. The flow cell 1 of this working example diminishes a stagnation around a flow inlet of the detecting portion.

FIG. 7 illustrates a flow cell 1 comprising a detecting portion 2, two circling inflow channels 33, 34, and two branched outflow channels 41, 42. The sample fluid, which flows from an upstream tube 5 into the flow cell 1, is led from the circling inflow channels 33, 34 through flow inlets 303, 304 into the detecting portion 2, is further led from the detecting portion 2 through flow outlets 401, 402, into the branched outflow channels 41, 42, and rejoins downstream into a single stream to flow through the rejoining outflow channel 45 into a downstream tube 6. The two circling inflow channels 33, 34 lead a sample fluid into the detecting portion in directions, which are each offset from a direction to the central axis of detecting portion 21, and which are symmetrical with respect to the central axis of the detecting portion 21. The number of the outflow channels does not have to be restricted to two, and the flow cell 1 may be provided with a single outflow channel like a conventional flow cell, with more than two of the outflow channels as shown in FIG. 4, or with an encircling outflow channel disposed all along a circumference of the detecting portion as shown in FIG. 5. The emitted detecting light 109 comes through an upstream end face of detecting portion 201 into the detecting portion 2, and goes out of the detecting portion 2 through a downstream end face of detecting portion 202. Alternatively, the emitted detecting light 109 may come through the downstream end face of detecting portion 202 into the detecting portion 2, and may go out of the detecting portion 2 through the upstream end face of detecting portion 201.

The inertia of the flow of the sample fluid led from the circling inflow channels 33, 34 into the detecting portion makes the flow a jet.

Each of the circling inflow channels 33, 34 leads the sample fluid in a direction not intersecting the central axis of detecting portion 21. Therefore, the incoming jet from each of the circling inflow channels makes a circular flow along a surface of an inner wall of the detecting portion 2. The inertia of the jet is lost in a short distance due to a generated friction between the jet and the surface of the inner wall of the detecting portion 2, leading to a dissipation of the jet. Accordingly, the generated vortex accompanying the jet is scaled down. When the detecting portion is provided with two of the inflow channels, an incoming jet from one of the inflow channels suppress a generation of a vortex by an incoming jet from the other inflow channel. Therefore, the generated vortex is further scaled down than the vortex generated in a conventional flow cell. As a result, a sample molecule can come out of the vortex in a shorter time leading to a suppression of a peak broadening of a chromatogram.

### Working Example 4

In following paragraphs, the fourth working example of the present invention is described with reference to FIG. 8. FIG. 8 illustrates a flow cell comprising a detecting portion 2, four circling inflow channels 33, 34, 35, 36 and a single outflow channel 4. The sample fluid, which flows from an upstream tube 5 into the flow cell 1, is led from the circling inflow channels 33, 34, and 35, 36, all of which are connected to either of both ends of the detecting portion 2, into the detecting portion 2, and is further led from the detecting portion 2 into the single outflow channels 4 to flow into a downstream tube 6. Like the circling inflow channel of the third working example, the four circling inflow channels 33, 34, 35, 36 lead a sample fluid into the detecting portion in directions, which do not intersect the central axis of the detecting portion 21 to be offset from a direction to the central axis of the detecting portion 21, and which are symmetrical with respect to the central axis of the detecting portion 21.

The smaller size of the vortex generated around the flow inlet inside the detecting portion of a flow cell of the present invention than a vortex produced by a conventional flow cell can suppress a peak broadening of chromatogram. As a result, the accuracy of analysis of a liquid chromatograph can be improved.

FIG. 9 illustrates an output of a simulation of a peak broadening of chromatogram produced by a conventional flow cell and the flow cells illustrated in FIGS. 3, 6, and 7. A half height width of a peak is taken as an indicator of a degree of the peak broadening of chromatogram. With a half height width produced by a conventional flow cell taken as 100%, a relative half height width produced by the flow cells illustrated in FIGS. 3, 6, and 7 are presented. Each of the examples reveals that a peak broadening produced by a flow cell of the present invention is more suppressed than a peak broadening produced by a conventional flow cell.

### BRIEF DESCRIPTION OF THE DRAWINGS

FIG. 1 illustrates a configuration of a liquid chromatograph of the present invention.

FIG. 2 is a schematic view of a chromatogram of the present invention.

FIG. 3 illustrates a configuration of a flow cell of the present invention provided with two branched outflow channels.

FIG. 4 illustrates a configuration of a flow cell of the present invention provided with three branched outflow channels.

FIG. 5 illustrates a configuration of a flow cell of the present invention provided with an encircling outflow channel.

FIG. 6 illustrates a configuration of a flow cell of the present invention provided with two branched inflow channels and with two branched outflow channels.

FIG. 7 illustrates a configuration of a flow cell of the present invention provided with two circling inflow channels and with two of branched outflow channels.

FIG. 8 illustrates a configuration of a flow cell of the present invention provided with four circling inflow channels and with a single outflow channel.

FIG. 9 illustrates an output of a simulation of a peak broadening of chromatogram produced by flow cells.

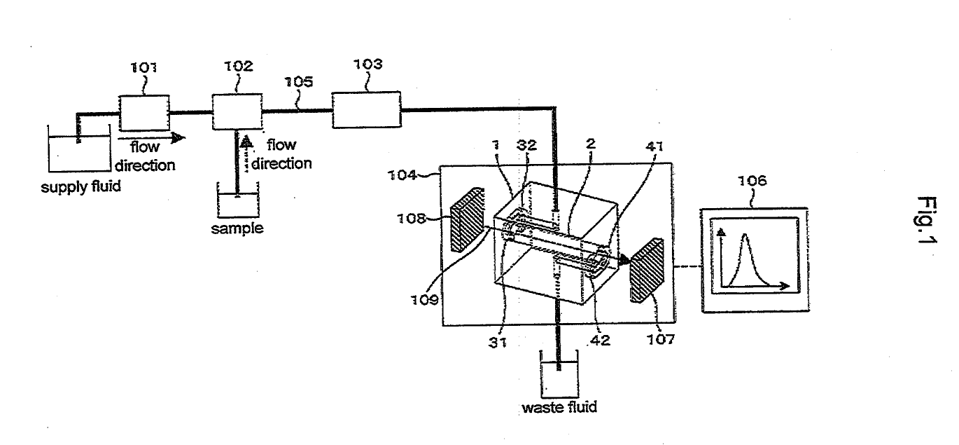

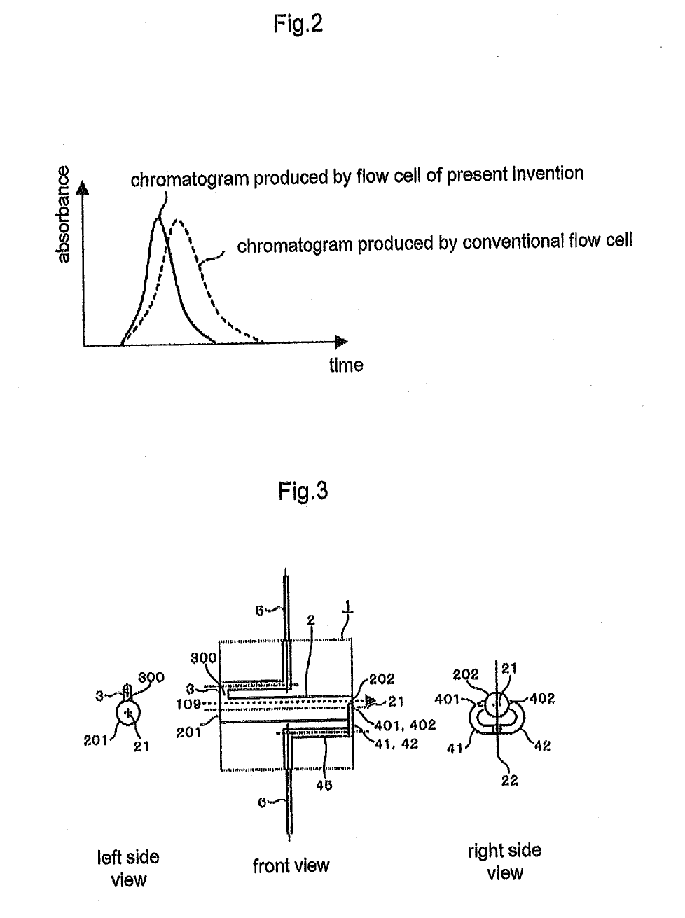

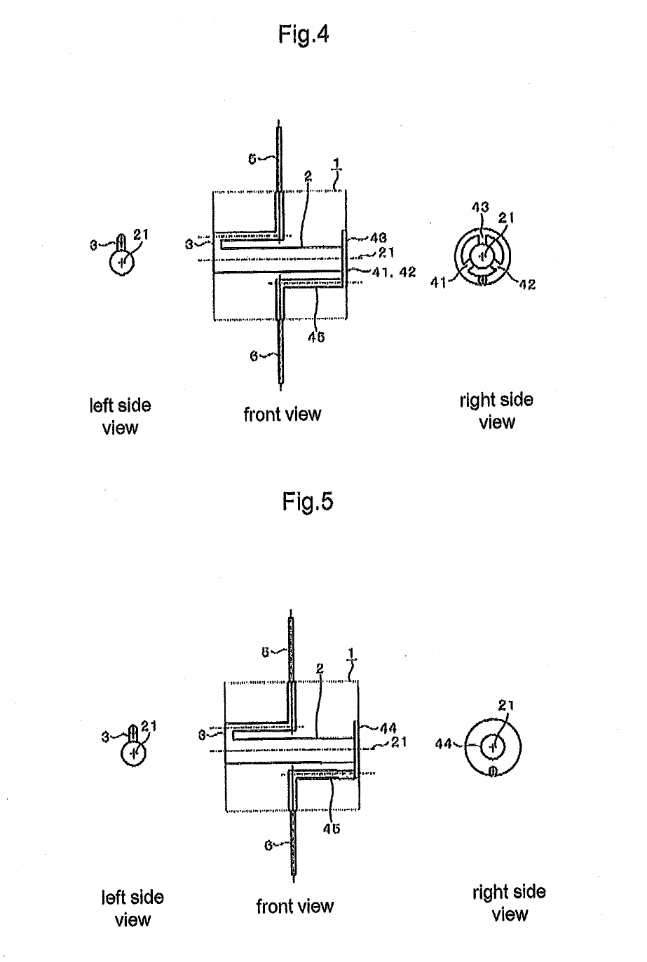

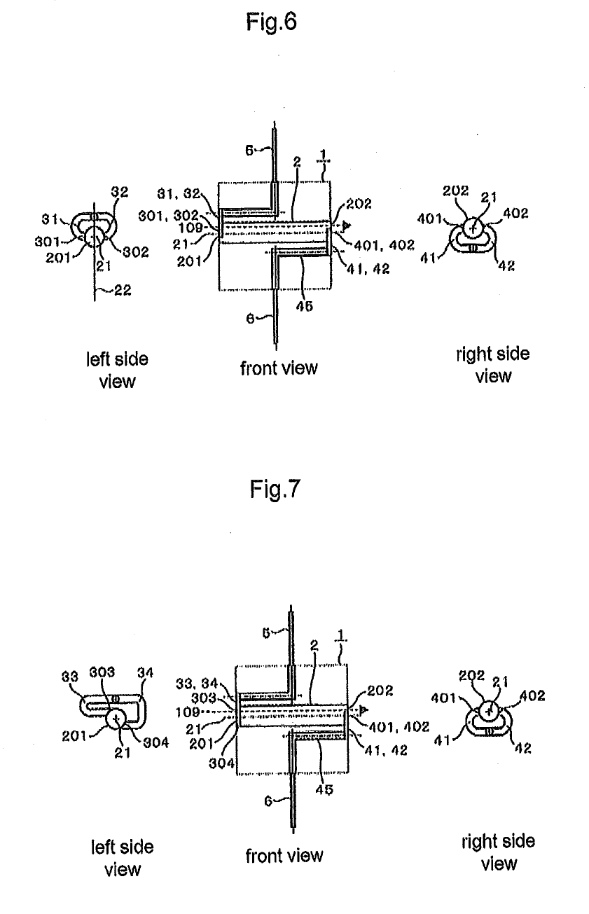

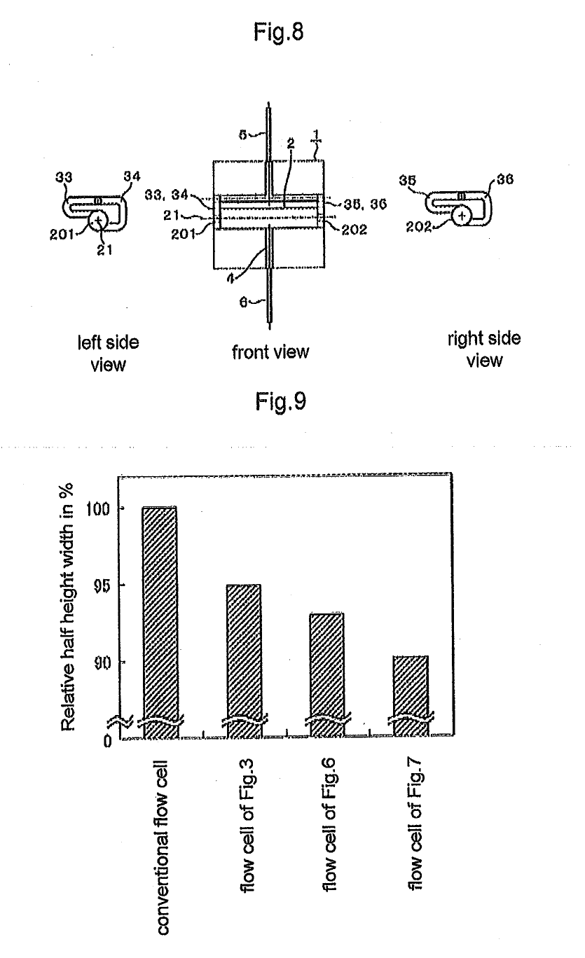

### LIST OF NUMERAL REFERENCES

1 flow cell
2 detecting portion
3 single inflow channel
4 single outflow channel
5 upstream tube
6 downstream tube
21 central axis of detecting portion
22 central plane of detecting portion
31 branched inflow channel
32 branched inflow channel
33 circling inflow channel
34 circling inflow channel
35 circling inflow channel
36 circling inflow channel
41 branched outflow channel
42 branched outflow channel
43 branched outflow channel
44 encircling outflow channel
45 rejoining outflow channel
101 fluid supply pump
102 sample injector
103 separation column
104 detector
105 tubing
106 recorder
107 photo detector
108 light source
109 detecting light
201 upstream end face of detecting portion
202 downstream end face detecting portion
300 flow inlet
301 flow inlet
302 flow inlet
401 flow outlet
402 flow outlet

What is claimed is:

1. A flow cell comprising:
a detecting portion, in which a sample fluid is irradiated with a detecting light;
an inflow portion leading the sample fluid into the detecting portion in a direction different from a flow direction of the sample fluid inside the detecting portion; and
an outflow portion leading the sample fluid out of the detecting portion in a direction different from the flow direction of the sample fluid inside the detecting portion;
in such a way that an emitting direction of the detecting light and the flow direction of the sample fluid inside the detecting portion are parallel to each other,
wherein,
the outflow portion is provided with one or more channels leading the sample fluid out of the detecting portion in a plurality of directions.

2. The flow cell of claim 1, wherein the one or more channels in the outflow portion lead the sample fluid in the plurality of directions to later rejoin to make a single stream.

3. The flow cell of claim 2, wherein the sample fluid is led out of the detecting portion in the direction intersecting the emitting direction of the detecting light with a right angle.

4. The flow cell of claim 2, wherein the sample fluid is led out of the detecting portion in a plurality of radial directions.

5. The flow cell of claim 2, wherein:
the inflow portion comprises channels to lead the sample fluid into branched streams before the detecting portion to make the branched streams rejoin in the detecting portion; and
the branched streams are led into the detecting portion in directions, which are offset from a direction to the central axis of the detecting portion, and which are symmetrical with respect to the central axis of the detecting portion.

6. The flow cell of claim 1, wherein the channels lead the sample fluid out of the detecting portion in two different directions symmetrical with respect to a central plane including the central axis of the detecting portion.

7. The flow cell of claim 1, wherein the channels lead the sample fluid out of the detecting portion in more than two different directions symmetrical with respect to a center of the end face of the detecting portion.

8. The flow cell of claim 7, wherein the sample fluid is led out of the detecting portion in a plurality of radial directions.

9. The flow cell of claim 1, wherein the outflow portion leads the sample fluid out of the detecting portion in the direction intersecting the emitting direction of the detecting light with a right angle.

10. The flow cell of claim 1, wherein:
the inflow portion comprises channels to lead the sample fluid into branched streams before the detecting portion to make the branched streams rejoin in the detecting portion; and
the inflow portion leads the sample fluid into the detecting portion in the direction intersecting the central axis of the detecting portion.

11. The flow cell of claim 10, wherein the inflow portion leads the sample fluid into the detecting portion in the direction intersecting the central axis of the detecting portion with a right angle.

12. The flow cell of claim 1, wherein:
the inflow portion comprises channels to lead the sample fluid into branched streams before the detecting portion to make the branched streams rejoin in the detecting portion; and
the branched streams are led into the detecting portion in directions, which are offset from a direction to the central axis of the detecting portion, and which are symmetrical with respect to the central axis of the detecting portion.

13. A flow cell comprising:
a detecting portion, in which a sample fluid is irradiated with a detecting light;
an inflow portion leading the sample fluid into the detecting portion in a direction different from a flow direction of the sample fluid inside the detecting portion; and
an outflow portion leading the sample fluid out of the detecting portion in a direction different from the flow direction of the sample fluid inside the detecting portion;
in such a way that an emitting direction of the detecting light and the flow direction of the sample fluid inside the detecting portion are parallel to each other,
wherein:
the inflow portion comprises channels connected to both ends of the detecting portion to lead the sample fluid into branched streams before the detecting portion to make the branched streams rejoin in the detecting portion; and
the branched streams are led into the detecting portion in directions, which are offset from a direction to the central axis of the detecting portion, and which are symmetrical with respect to the central axis of the detecting portion.

14. A detector comprising:
a flow cell comprising:
a detecting portion, in which a sample fluid is irradiated with a detecting light;
an inflow portion leading the sample fluid into the detecting portion; and
an outflow portion leading the sample fluid out of the detecting portion;
a light source emitting the detecting light towards the detecting portion; and
a photo detector receiving the detecting light, which has passed through the detecting portion,
wherein:
an emitting direction of the detecting light and a flow direction of the sample fluid inside the detecting portion are parallel to each other;
the inflow portion leads the sample fluid into the detecting portion in a direction different from a flow direction of the sample fluid inside the detecting portion; and
the outflow portion leads the sample fluid out of the detecting portion in a plurality of directions different from the flow direction of the sample fluid inside the detecting portion.

15. The detector of claim 14, wherein the outflow portion leads the sample fluid in the plurality of directions to later rejoin to make a single stream.

16. A liquid chromatograph comprising:
a fluid supply pump pumping a supply fluid;
an injector mixing a sample with the supply fluid;
a separation column processing a sample fluid sent from the injector;
a detector detecting an intensity of a detecting light after an irradiation with the detecting light of the sample fluid processed by the separation column; and
a recorder recording an output from a measurement of the sample fluid on the basis of the intensity of the detecting light detected by the detector,
wherein:
the detector comprises:
a light source emitting the detecting light;
a photo detector receiving the detecting light; and
a flow cell comprising:
a detecting portion, in which the sample fluid flows in such a way that an emitting direction of the detecting light and a flow direction of the sample fluid inside the detecting portion are parallel to each other;
an inflow portion leading the sample fluid into the detecting portion; and
an outflow portion leading the sample fluid out of the detecting portion;
the inflow portion leads the sample fluid into the detecting portion in a direction different from the flow direction of the sample fluid inside the detecting portion; and
the outflow portion leads the sample fluid out of the detecting portion in a plurality of directions different from the flow direction of the sample fluid inside the detecting portion.

17. A liquid chromatograph of claim 16, wherein the outflow portion leads the sample fluid in the plurality of directions to later rejoin to make a single stream.
